(19) United States
(12) Patent Application Publication
(10) Pub. No.: US 2012/0096374 A1
(43) Pub. Date: Apr. 19, 2012

(54) COMPUTER MODELING

(75) Inventors: Jyrki Veikko Leskelä, Haukipudas (FI); Mika Allan Salmela, Oulu (FI); Jarmo Antero Nikula, Jaali (FI)

(73) Assignee: Nokia Corporation

(21) Appl. No.: 12/906,569

(22) Filed: Oct. 18, 2010

(51) Int. Cl. G06F 3/048

(52) U.S. Cl. 715/764

(57) ABSTRACT

A method, apparatus and computer program are provided. a method, comprising: controlling a display to display a user movable lamina modeled using an array of particles; and controlling movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

### TECHNOLOGICAL FIELD

Embodiments of the present invention relate to computer modeling. In particular, they relate to modeling a flexible lamina such as a leaf of an electronic book.

### BACKGROUND

An electronic book (also known as an ‘e-book’) is a digital version of a printed publication, such as a conventional book, magazine or newspaper.

In many circumstances, it is not possible to turn a page of an e-book displayed on a display. Instead, a user may have to use a scrolling facility to read pages of the e-book. This can feel very artificial for a user that is used to reading conventional books, magazines and newspapers.

### BRIEF SUMMARY

According to some, but not necessarily all, embodiments of the invention there is provided a method, comprising: controlling a display to display a user movable lamina modeled using an array of particles; and controlling movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

According to some, but not necessarily all, embodiments of the invention there is provided an apparatus, comprising: at least one memory storing a computer program comprising computer program instructions; and at least one processor configured to execute the computer program instructions to cause the apparatus at least to perform: controlling a display to display a user movable lamina modeled using an array of particles; and controlling movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

According to some, but not necessarily all, embodiments of the invention there is provided a non-transitory computer readable medium storing a computer program comprising computer program instructions that, when executed by at least one processor, cause at least the following to be performed: controlling a display to display a user movable lamina modeled using an array of particles; and controlling movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

According to some, but not necessarily all, embodiments of the invention there is provided an apparatus, comprising: means for controlling a display to display a user movable lamina modeled using an array of particles; and means for controlling movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

According to some, but not necessarily all, embodiments of the invention there is provided an apparatus, comprising: at least one memory storing a computer program comprising computer program instructions; and at least one processor configured to execute the computer program instructions to cause the apparatus at least to perform: controlling a display to provide a user selectable option for setting the stiffness of a user bendable lamina; and controlling the display to display a user bendable lamina having the stiffness selected by the user.

According to some, but not necessarily all, embodiments of the invention there is provided a method, comprising: controlling a display to provide a user selectable option for setting the stiffness of a user bendable lamina; and controlling the display to display a user bendable lamina having the stiffness selected by the user.

According to some, but not necessarily all, embodiments of the invention there is provided a non-transitory computer readable medium storing a computer program comprising computer program instructions that, when executed by at least one processor, cause at least the following to be performed: controlling a display to provide a user selectable option for setting the stiffness of a user bendable lamina; and controlling the display to display a user bendable lamina having the stiffness selected by the user.

According to some, but not necessarily all, embodiments of the invention there is provided an apparatus, comprising: means for controlling a display to provide a user selectable option for setting the stiffness of a user bendable lamina; and means for controlling the display to display a user bendable lamina having the stiffness selected by the user.

According to some, but not necessarily all, embodiments of the invention there is provided a method, comprising: controlling a display to display a user movable lamina modeled using an array of particles including at least first, second and third particles; and controlling movement of the user movable lamina on the display by controlling relative spacing of the first particle and the second particle using a first distance relationship, by controlling relative spacing of the second particle and the third particle using the first distance relationship and by controlling relative spacing of the first particle and the third particle using a second distance relationship, wherein the second distance relationship is different to the first distance relationship.

According to some, but not necessarily all, embodiments of the invention there is provided an apparatus, comprising: at least one memory storing a computer program comprising computer program instructions; and at least one processor configured to execute the computer program instructions to cause the apparatus at least to perform: controlling a display to display a user movable lamina modeled using an array of particles including at least first, second and third particles; and controlling movement of the user movable lamina on the display by controlling relative spacing of the first particle and the second particle using a first distance relationship, by controlling relative spacing of the second particle and the third particle using the first distance relationship and by controlling relative spacing of the first particle and the third particle using a second distance relationship, wherein the second distance relationship is different to the first distance relationship.

According to some, but not necessarily all, embodiments of the invention there is provided a non-transitory computer readable medium storing a computer program comprising computer program instructions that, when executed by at least one processor, cause at least the following to be performed: controlling a display to display a user movable lamina modeled using an array of particles including at least first, second and third particles; and controlling movement of the user movable lamina on the display by controlling relative spacing of the first particle and the second particle using a first distance relationship, by controlling relative spacing of the second particle and the third particle using the first distance relationship and by controlling relative spacing of the first particle and the third particle using a second distance relationship, wherein the second distance relationship is different to the first distance relationship.

According to some, but not necessarily all, embodiments of the invention there is provided an apparatus comprising: means for controlling a display to display a user movable lamina modeled using an array of particles including at least first, second and third particles; and means for controlling movement of the user movable lamina on the display by controlling relative spacing of the first particle and the second particle using a first distance relationship, by controlling relative spacing of the second particle and the third particle using the first distance relationship and by controlling relative spacing of the first particle and the third particle using a second distance relationship, wherein the second distance relationship is different to the first distance relationship.

### BRIEF DESCRIPTION

For a better understanding of various examples of embodiments of the present invention reference will now be made by way of example only to the accompanying drawings in which:

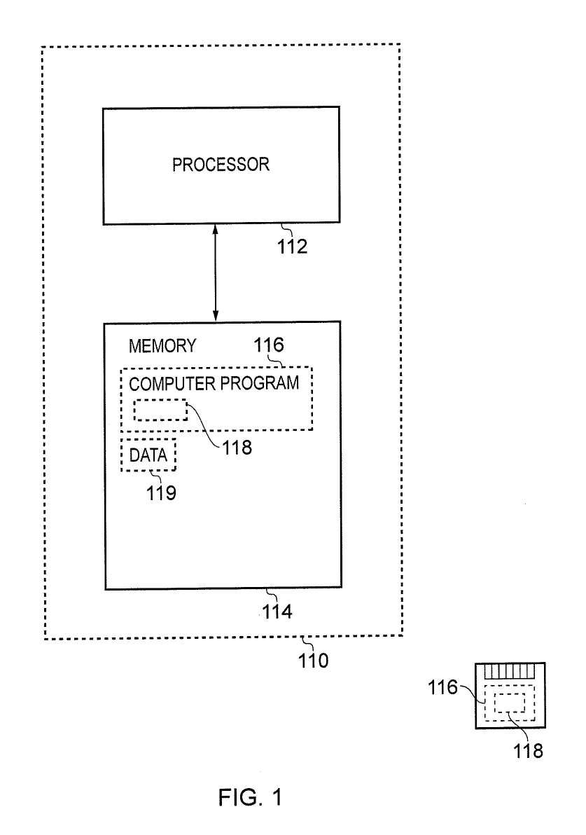

FIG. 1 illustrates an apparatus;

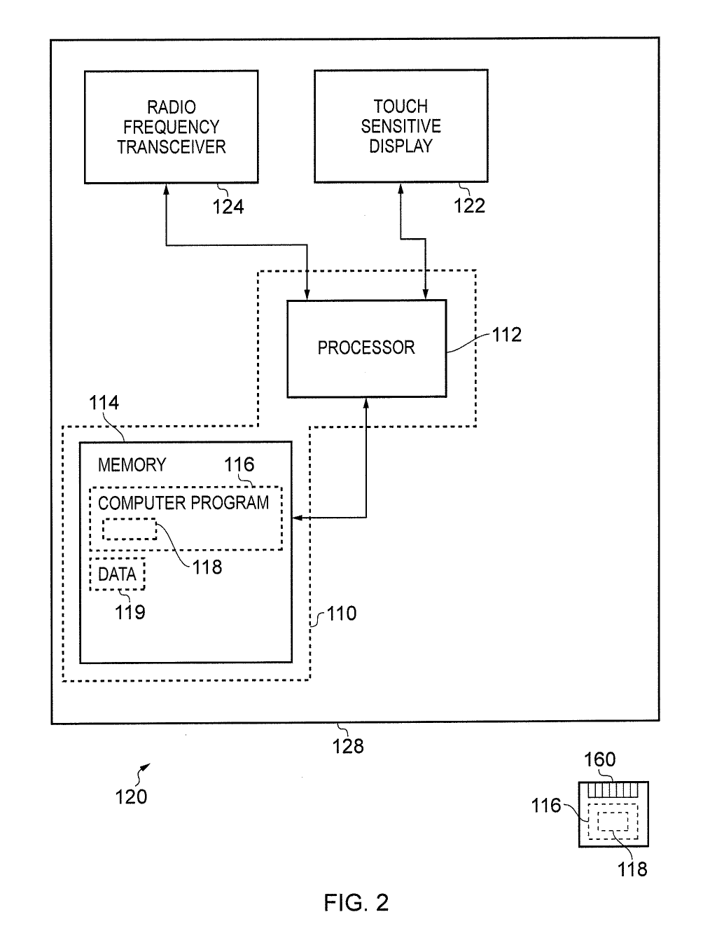

FIG. 2 illustrates a further apparatus;

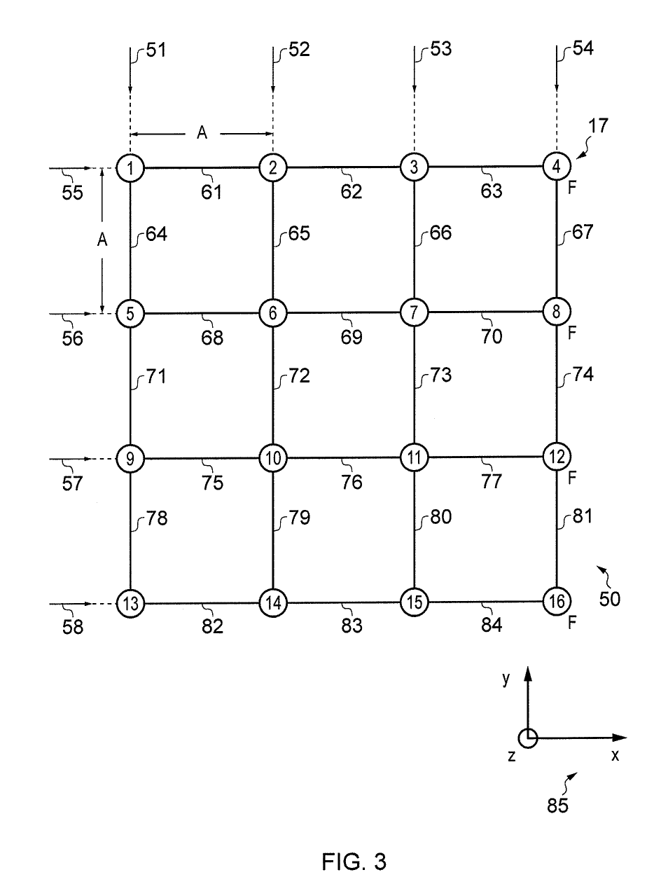

FIG. 3 illustrates a lamina at rest, modeled using an array of particles;

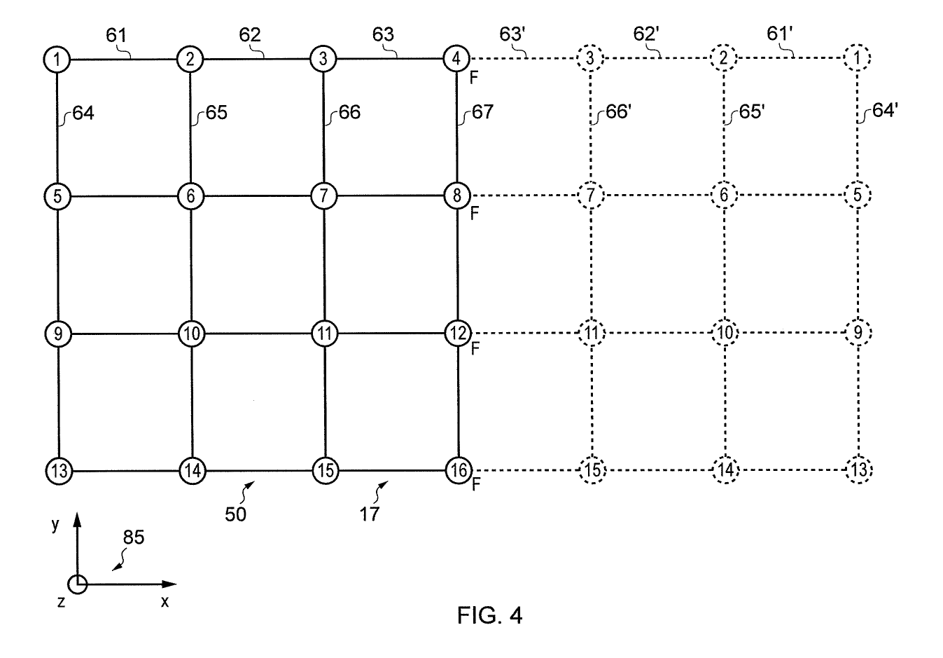

FIG. 4 illustrates the lamina in a first position and in a second position, following rotation;

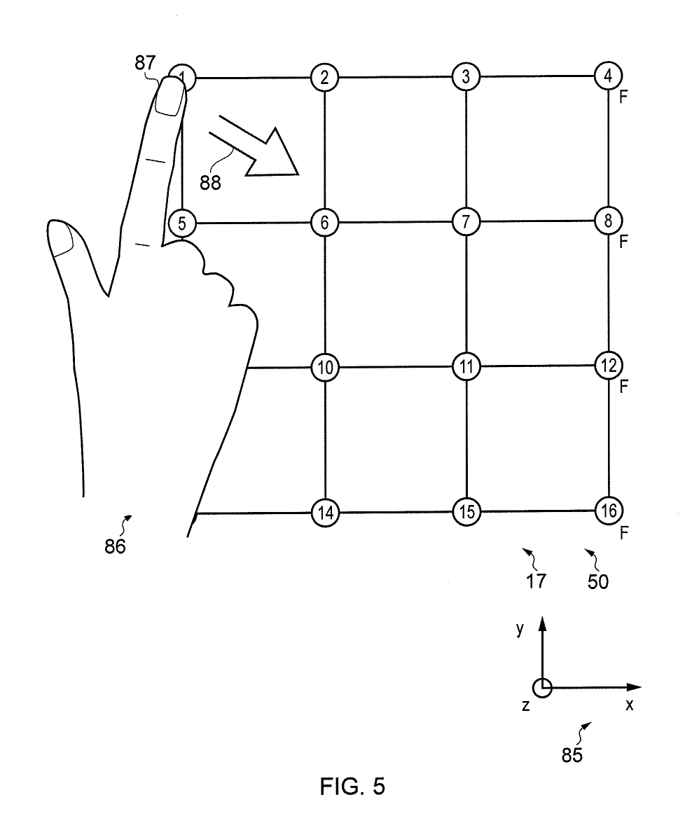

FIG. 5 illustrates a user finger swipe for causing movement of the lamina;

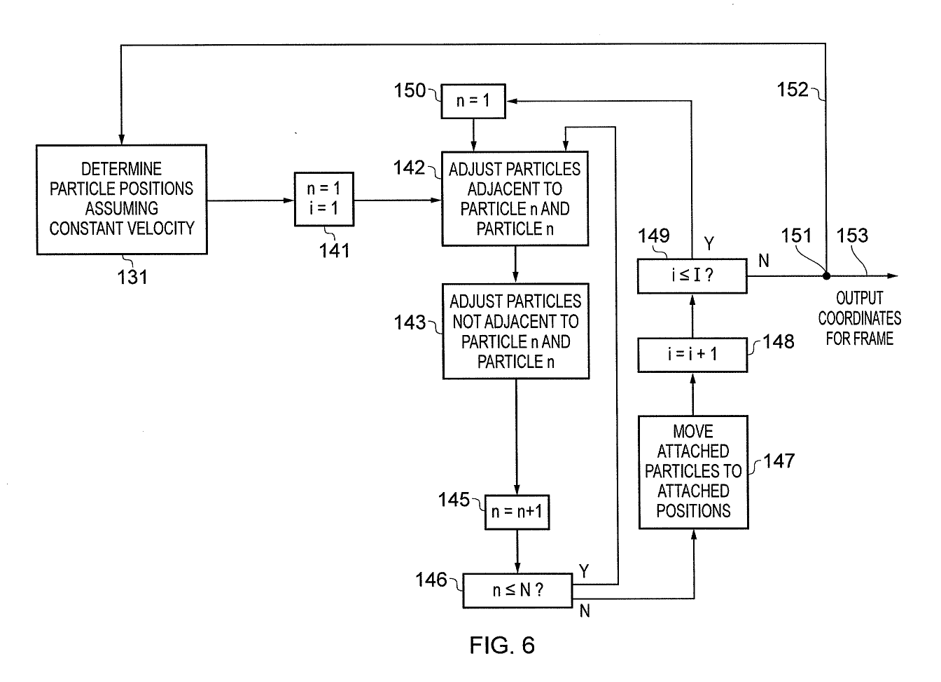

FIG. 6 illustrates a flow chart of a method;

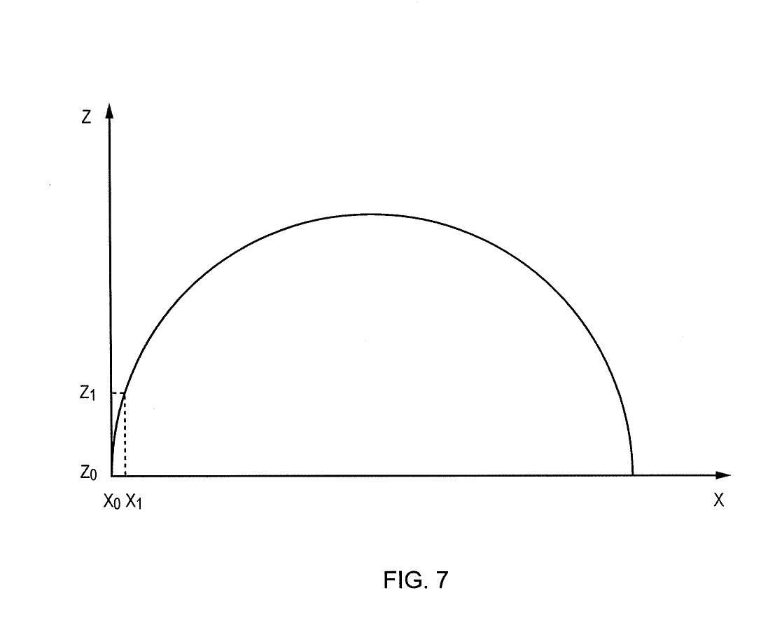

FIG. 7 illustrates an example of movement of particles in an x-z plane;

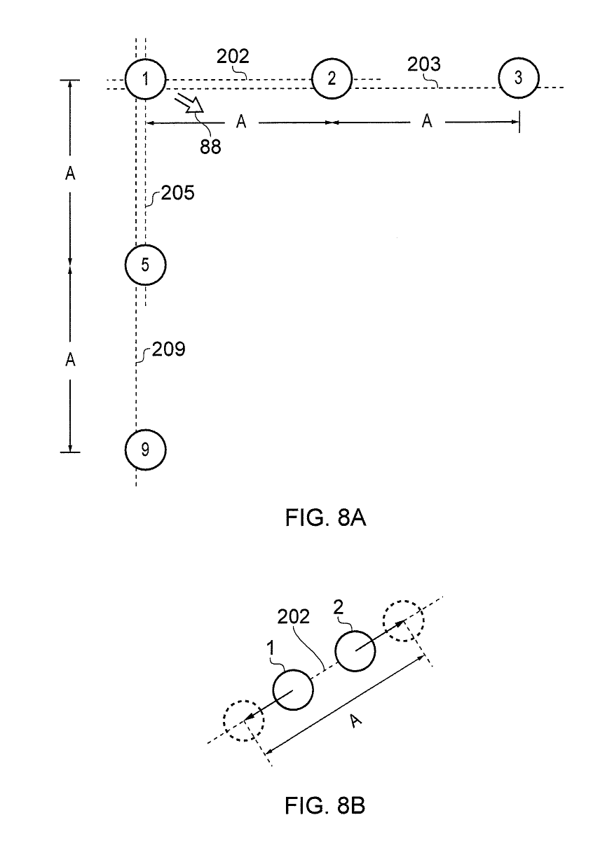

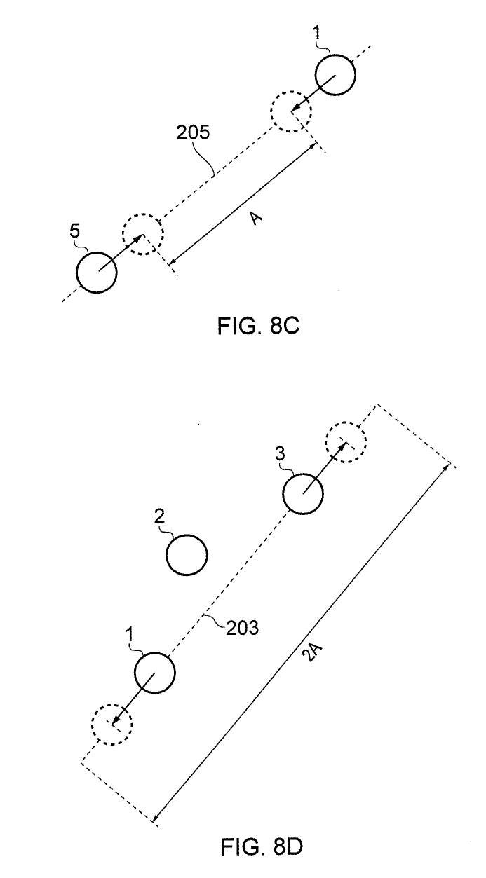

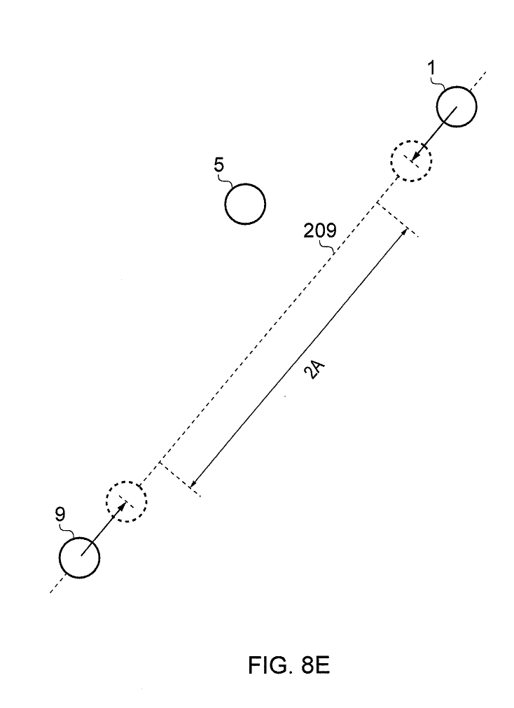

FIG. 8A illustrates a portion of the array of particles;

FIGS. 8B, 8C, 8D and 8E illustrate how movement of the lamina is controlled by applying distance relationships to particles in the array;

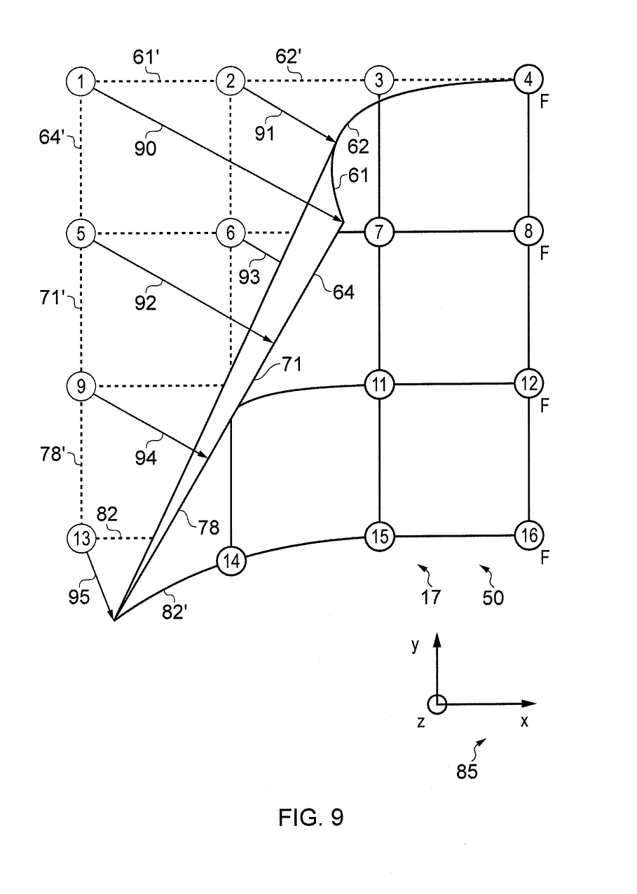

FIG. 9 illustrates movement of the lamina;

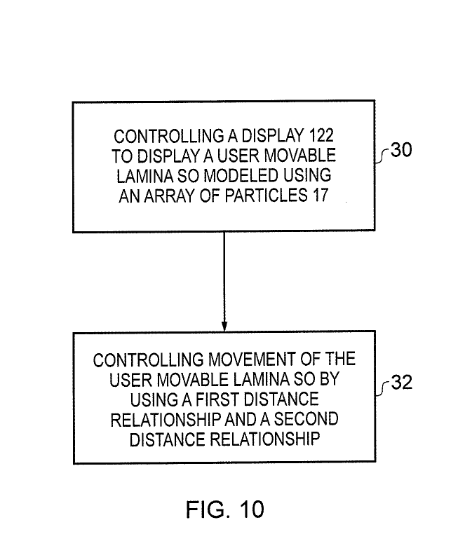

FIG. 10 illustrates a further method; and

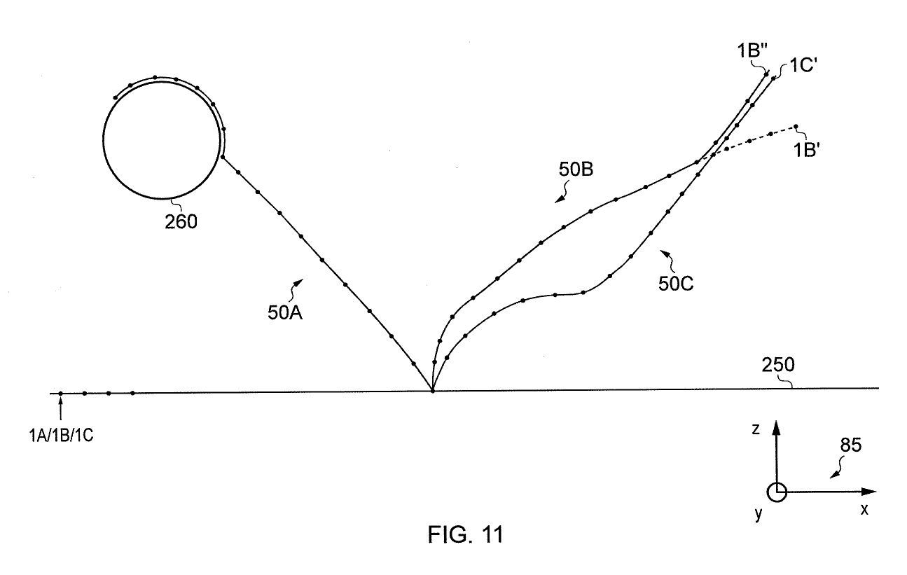

FIG. 11 illustrates positions of laminas being adjusted according to external constraints.

### DETAILED DESCRIPTION

Embodiments of the invention relate to modeling a user movable lamina such as a leaf of an electronic book. In this regard, the figures illustrate an apparatus 110/120, comprising: at least one memory 114 storing a computer program 116 comprising computer program instructions 118; and at least one processor 112 configured to execute the computer program instructions 118 to cause the apparatus 110/120 at least to perform: controlling a display 122 to display a user movable lamina 50 modeled using an array of particles 17; and controlling movement of the user movable lamina 50 on the display 122 by controlling, using a first distance relationship, relative spacing of a first particle in the array 17 and at least one other particle adjacent to the first particle in the array 17, and by controlling, using a second distance relationship, relative spacing of the first particle and at least one further particle not adjacent to the first particle in the array 17.

FIG. 1 illustrates an example of an apparatus 110. The apparatus 110 may, for example, be a chip or a chip-set. The apparatus 110 illustrated in FIG. 1 comprises a processor 112 and a memory 114. In alternative embodiments of the invention, the apparatus 110 may comprise multiple different processors and the functions of the processor 112 described below may be performed by the multiple different processors.

The processor 112 is configured to read from and write to the memory 114. The processor 112 may also comprise an output interface via which data and/or commands are output by the processor 112 and an input interface via which data and/or commands are input to the processor 112.

Although the memory 114 is illustrated as a single component, it may be implemented as one or more separate components, some or all of which may be integrated/removable and/or may provide permanent/semi-permanent/dynamic/cached storage.

The memory 114 is illustrated in FIG. 1 storing a computer program 116 and data 119. The data 119 will be described in further detail below. The computer program 116 comprises computer program instructions 118 that control the operation of the apparatus 110/120 when loaded into the processor 112. The computer program instructions 118 provide the logic and routines that enables the apparatus 110/120 to perform the methods illustrated in FIGS. 6 and 10. The processor 112, by reading the memory 114, is able to load and execute the computer program instructions 118.

The computer program 116 may arrive at the apparatus 110/120 via any suitable delivery mechanism 160. The delivery mechanism 160 may be, for example, a tangible, non-transitory computer-readable storage medium, a computer program product, a memory device, a record medium such as a Compact Disc, a Digital Versatile Disc or Blu-Ray disc, or any article of manufacture that tangibly embodies the computer program 116. The delivery mechanism 160 may also be a signal configured to reliably transfer the computer program 116.

FIG. 2 illustrates an example of a further apparatus 120. The apparatus 120 illustrated in FIG. 2 may, for example, be a hand portable electronic device such as a mobile telephone, a personal music player, a personal digital assistant, a tablet computer, or a games console. In alternative embodiments of the invention, the apparatus 120 is not hand portable and may, for instance, be a desktop personal computer.

The apparatus 120 illustrated in FIG. 2 comprises the apparatus 110 illustrated in FIG. 1. In this particular example, the apparatus 120 further comprises a housing 128, a touch sensitive display 122 and a radio frequency transceiver 124. For clarity reasons, only a single radio frequency transceiver 124 is illustrated in FIG. 2. However, in practice, the apparatus 120 may comprise multiple (different) radio frequency transceivers or may not comprise any radio frequency transceivers.

In this example, the housing 128 houses: the processor 112, the memory 114, the touch sensitive display 122 and the radio frequency transceiver 124. The elements 112, 114, 122 and 124 are co-located within the housing 28. The elements 112, 114, 122 and 124 are operationally coupled and any number or combination of intervening elements can exist (including no intervening elements).

The processor 112 is configured to provide outputs to and receive inputs from the touch sensitive display 122. The touch sensitive display 122 may, for example, operate using resistive, capacitive or acoustic wave technology or a combination of these technologies. In some embodiments of the invention, the touch sensitive display 122 is configured to detect (only) a single touch at any one time. In other embodiments of the invention, the touch sensitive display 122 is configured to detect multiple touches, at different locations on the display 122, at any one time.

The processor 112 is configured to receive inputs from and provide outputs to the radio frequency transceiver 124. The radio frequency transceiver 124 is configured to transmit and receive radio frequency signals. The radio frequency transceiver 124 may, for example, be a cellular transceiver that is compatible with one or more cellular protocols such as GSM (Global System for Mobile Communications), IS-95 (Interim Standard 95) or UMTS (Universal Mobile Telecommunications System). Alternatively, the radio frequency transceiver 124 may be a short range transceiver that is compatible with one or more short range protocols, such as Bluetooth protocols or IEEE (Institute of Electrical and Electronic Engineers) protocols. In some embodiments of the invention, the apparatus 120 comprises one or more cellular transceivers and one or more short range transceivers.

FIG. 3 illustrates an example of a lamina 50 for display on the touch sensitive display 122. The lamina 50 has four sides and is modeled using an array of particles 17. In this example, the array 17 includes sixteen particles, numbered 1 to 16, in a 4×4 square arrangement. The array 17 includes four columns 51-54 and four rows 55-58. In other examples, the array 17 may include a different number of particles in a different arrangement. For example, the array may be rectangular in shape or have another, alternative shape. If the array is rectangular in shape and has particles arranged in rows and columns, the number of rows in the array is different to the number of columns. In some implementations of the invention, the array of particles may not be arranged in rows and columns.

In the FIG. 3 example, particles 1 to 4 are positioned in the first row 55. Particles 5 to 8 are positioned in the second row 56. Particles 9 to 12 are positioned in the third row 57. Particles 13 to 16 are positioned in the fourth row 58.

Particles 1, 5, 9 and 13 are positioned in the first column 51. Particles 2, 6, 10 and 14 are positioned in the second column 52. Particles 3, 7, 11 and 15 are positioned in the third column 53. Particles 4, 8, 12 and 16 are positioned in the fourth column 54.

FIG. 3 illustrates interconnects 61-84 connecting adjacent particles together to form a grid. The “adjacent particle(s)” to a given particle may be considered to be the particle(s) that is/are positioned closest to the given particle when the lamina 50 is at rest. In this example, an “adjacent particle” to a given particle is considered to be a particle that is positioned in the same row as the given particle and an immediately adjacent column, or a particle that is positioned in same column as the given particle and an immediately adjacent row. In this example, “adjacent particles” are either spaced horizontally from a given particle in the array 17, or spaced vertically from the given particle in the array 17.

For example, particles 2 and 5 are both considered to be adjacent to particle 1. Particle 2 is connected to particle 1 via interconnect 61. Particle 5 is connected to particle 1 by interconnect 64. In the example illustrated in FIG. 3, a particular particle may have two, three or four adjacent particles.

FIG. 3 shows the lamina 50 at rest. When the lamina 50 is at rest, each particle is horizontally or vertically spaced from its adjacent particles by a distance A.

A co-ordinate system 85 including x, y and z axes is illustrated in FIG. 3. The x axis is parallel with each of the rows 55-58 and perpendicular to each of the columns 51-54. The y-axis is parallel with each of the columns 51-54 and perpendicular to each of the rows 55-58. The z-axis extends out of the page.

In practice, when the lamina 50 is displayed in the display 122, it is displayed as a continuous surface. One or more images are mapped onto the lamina 50 to make it appear on the display 122 as a continuous surface. The particles 1-16 and the interconnects 61-84 are not visible to the user when the lamina 50 is displayed on the display 122. The particles 1-16 and the interconnects 61-84 are merely illustrated to explain the functionality of embodiments of the invention.

The lamina 50 is a substantially two-dimensional object. That is, the lamina's extent in the x-direction and the y-direction is much larger than its extent in the z-direction.

The lamina 50 may, for example, be a leaf in an electronic book (for instance, in the form of a newspaper, magazine, novel, reference book, photo album, etc). In this regard, the image or images mapped onto the lamina 50 may include text and/or pictures. In other embodiments of the invention, the lamina 50 may, for example, be an application window in an operating system or other application.

The particles in the fourth column 54 (particles 4, 8, 12 and 16) are marked with an “F” in FIG. 3. This indicates that these particles are substantially fixed in their current positions. In this example, the lamina 50 is rotatable about the fourth column 54 of particles. In an example where the lamina 50 is a leaf of an electronic book, the fixed particles 4, 8, 12, 16 may be considered to be connected to the spine of the book.

FIG. 4 illustrates the lamina 50 in a first position (the solid line) and in a second position (the dotted lines). The reference numerals 61′-66′ indicate the position of the interconnects 61-66 when the lamina 50 is in the second position. The second position is a reflection of the first position. The line of reflection is defined, in this example, by fourth column 54.

When the lamina 50 is in the first position, a first face of the lamina 50 is displayed on the display 122. When the lamina 50 is in the second position, a second face of the lamina 50 is display on the display 122. In an example where the lamina 50 is a leaf of an electronic book, a first page is displayed on the display 122 when the lamina is in the first position and a second page is displayed on the display 122 when the lamina 50 is in the second position.

An example of a method according to embodiments of the invention will now be described in relation to the figures.

The processor 112 controls the touch sensitive display 122 to display the lamina 50 illustrated in FIG. 3. The user 86 then touches the display 122 using a digit 87. This is illustrated in FIG. 5. The processor 112 receives information from the display 122 indicating that the user is touching the display 122 and indicating where the user is touching the display 122. The processor 112 analyses this information to determine whether the user is touching the display 122 at, or close to, a particle of the lamina 50. In this example, the user touches the lamina 50 at, or close to, particle 1 of the lamina 50. The user then swipes his finger across the surface of the display 122, in the direction of the arrow 88. This is illustrated in FIG. 5.

The example flow chart illustrated in FIG. 6 indicates how the computer program instructions 118 cause the processor 112 to simulate movement of the lamina 50 in response to detection of the user's finger swipe.

The flow chart begins at block 131. At block 131, the processor 112 determines whether any of the particles 1-16 in the array 17 are currently in motion, by comparing the current position of each particle 1-16 with its previous position. If the particles are in motion, the processor 112 assumes that the particles 1-16 are moving with a constant velocity and determines the next position of each particle by treating it as a free (unconnected) particle. Block 131 may be carried out using a Verlet Integration technique.

At this stage, each of the particles 1-17 are at rest; movement of the lamina 50 on the display 122 has not yet commenced. Movement of the lamina 50 begins when a first frame is output at arrow 153 on the right hand side of the flow chart in FIG. 6. Consequently, the “current position” of each particle is its rest position and the “previous position” of each particle is also its rest position. The processor 112 therefore determines, at this stage, that the next position of each particle is its “at rest” position.

At block 141, the processor 112 sets n to a value of 1 and i to a value of 1. n is a number that indicates the numbered particle that is being operated on in the flow chart in FIG. 6. i is an iteration number.

At block 142, the processor 112 adjusts the positions of particle n and particles adjacent to particle n, by controlling the relative spacing of particle n and each adjacent particle. This effectively acts to restrict the movement of adjacent particles in the array 17, causing them to behave as an interconnected system.

The relative spacing between particle n and a given adjacent particle is controlled by applying a first distance relationship to them. The first distance relationship defines a condition. In this example, the condition specifies that if particle n and an adjacent particle are not spaced a “rest length” away from each other, particle n and an adjacent particle are moved towards or away from one another by an equal amount until they are separated by a “rest length”. In this instance, a “rest length” between particle n and an adjacent particle is a distance of A, because a given particle is separated from an adjacent particle by a distance of A when the lamina 50 is at rest.

The processor 112 determines whether particle n and an adjacent particle are a “rest length” (a distance of A) away from one another by defining a line, in three dimensional space, that passes through particle n and the adjacent particle. If particle n and the adjacent particle are spaced by more or less than a “rest length”, the processor 112 adjusts the positions of particle n and the adjacent particle by moving both particle n and the adjacent particle along the line.

The relative spacing of particle n and each of its adjacent particles is adjusted sequentially. For example, once the relative spacing of particle n and a first adjacent particle has been adjusted as described above (if necessary), the relative spacing of particle n and a second adjacent particle is adjusted by applying the first distance relationship as described above. Adjustment of the relative spacing of particle n and the second adjacent particle may result in particle n moving closer or further away from the first adjacent particle.

At this stage in the flow chart of FIG. 6, n=1, so particle 1 is being operated upon. The first adjacent particle to particle 1 can be considered to be particle 2. However, since the present output from block 131 indicates that particles 1 and 2 are currently in their rest positions, no position adjustment of particles 1 and 2 is required at this stage. The second adjacent particle to particle 1 can be considered to be particle 5. However, since the present output from block 131 indicates that particles 1 and 5 are currently in their rest positions, no position adjustment of particles 1 and 5 is required at this stage.

At block 143 in FIG. 6, the processor 112 adjusts the positions of particle n and certain, selected particles that are not adjacent to particle n by controlling the spacing between them using a second distance relationship.

In this example, a particle is considered to be “non-adjacent” to particle n if, when the lamina 50 is at rest, it not considered to be an “adjacent particle” according to the definition provided above.

In this example, particles 3-4 and 6-16 are all considered to be “non-adjacent” to particle 1.

The non-adjacent particles that are “selected” may depend upon the effect that it is desired to achieve. For example, the inventors have found that controlling the relative spacing of non-adjacent particles that are (both) positioned on the edge of the lamina 50 increases the stiffness of the lamina 50 when it is moved.

The table below which particles might be selected non-adjacent particles for a given particle n to achieve this effect:

| | Selected non-adjacent |
|---|---|
| Number of particle (n) | particles |
| 1 | 3, 9 |
| 2 | 4 |
| 3 | 1 |
| 4 | 2, 12 |
| 5 | 13 |
| 6 | none |
| 7 | none |
| 8 | 16 |
| 9 | 1 |
| 10 | none |
| 11 | none |
| 12 | 4 |
| 13 | 5, 15 |
| 14 | 16 |
| 15 | 13 |
| 16 | 8, 14 |

It will be appreciated by those skilled in the art that this is merely an example. In this example, when the user movable lamina 50 is at rest each of the selected non-adjacent particles for a given particle n is positioned at an edge/side of the lamina 50 and:

a) in the row particle n resides in and in a column that is separated from the column that particle n resides in by one other column; or

b) in the column particle n resides in and in a row that is separated from the row that particle n resides in by one other row.

The relative spacing of particle n and a given selected non-adjacent particle is controlled by applying to second distance relationship to them. When applying the second distance relationship, the processor 112 determines the current spacing between particle n and a given selected non-adjacent particle. This is performed by defining a line, in three dimensional space, that passes through particle n and the selected non-adjacent particle. The processor 112 then determines the difference between the current spacing and a “rest length”.

In this instance, a “rest length” between particle n and a selected non-adjacent particle is a distance of 2A, because a given particle is separated from a selected non-adjacent particle by a distance of 2A when the lamina 50 is at rest.

The second distance relationship defines a condition that specifies that if particle n and a selected non-adjacent particle are spaced more or less than a “rest length” (of 2A) away from each other, particle n and the selected non-adjacent particle are moved towards or away from one another by a portion of the current difference in spacing. Particle n and the selected non-adjacent particle are moved by an equal amount along the defined line that passes through them.

The portion of the current difference in spacing that particle n and the selected non-adjacent particle are moved towards or away from one another will depend upon the implementation of the invention. By way of example, the portion could be 0.5. In such an implementation, if particle n and a selected non-adjacent particle were determined to be spaced a distance of 3A away from each other in block 143, the processor 112 would move the particles towards each other by a total relative distance of A (each particle would move 0.5 A).

At this stage in the flow chart of FIG. 6, n=1. A first selected non-adjacent particle to particle 1 can be considered to be particle 3. However, since particles 1 and 3 are presently in their rest positions, no adjustment of spacing of particles 1 and 3 is required at this stage. A second selected non-adjacent particle to particle 1 can be considered to be particle 9. However, since particles 1 and 9 are presently in their rest positions, no adjustment of the relative spacing of particles 1 and 5 is required at this stage.

The positions of the particles 1, 2, 3, 5 and 9 are stored in the memory 114 as part of the data 119.

At block 145 of FIG. 6, the processor 112 increments n by 1. At block 146, the processor 112 determines whether n is smaller than or equal to N. N is the total number of the particles in the array 17, which in this example is sixteen. At this stage in the flow chart of FIG. 6, n=2, so the flow chart returns to block 142. The first distance relationship is applied sequentially to particle 2 and each of its adjacent particles at block 142. The second distance relationship is applied sequentially to particle 2 and each of its adjacent particles at block 143. The processor 112 stores the position of particles in the memory 114 as part of the data 119.

This process continues until n reaches 17. When n reaches 17, it is larger than N, so the flow chart proceeds to block 147. At block 147 of FIG. 6, the processor 112 adjusts the position values for any particles that are “attached”. Particles 4, 8, 12 and 16 can be considered to be “attached” because they are fixed in position (and may, for example, be connected to the spine of an e-book).

If the adjustment of the position values in blocks 142 and 143 has resulted in position values being stored in the memory 114 for particles 4, 8, 12 and 16 that are different to the fixed positions of particles 4, 8, 12 and 16, the positions of particles 4, 8, 12 and 16 are adjusted back to their fixed positions.

At block 147, the processor 12 also controls particle 1 such that it is “attached” to the user's digit, because particle 1 was at (or close to) the position at which the user touched the display 122 before he swiped his digit. At block 147, the processor 112 detects that the user's digit is at a new position on the display 122 (due to the user being in the process of swiping his digit), and adjusts the position of particle 1 in the x and y dimensions such it corresponds with the position of the digit. Particle 1 therefore moves with the user's digit as the digit is being swiped across the display 122.

The display 122 has an extent in the x and y dimensions. In order to show the lamina 50 moving in three dimensions on the display 122, the processor 112 uses the adjusted position in one dimension (and possibly the adjusted position in the other dimension) for particle 1 to determine an position for particle 1 in the third dimension.

For example, in some embodiments of the invention, a relationship is used to map an “adjusted position” in the x dimension to a position in the z dimension for a particular particle. That is, when the position of an attached particle is adjusted to have a particular position in the x dimension, the processor 112 assigns that particle a particular position in the z dimension. In other embodiments of the invention, the adjusted position in the z dimension depends upon both the adjusted position of the attached particle in the x dimension and the adjusted position of the attached particle in the y dimension.

FIG. 7 illustrates an example of a relationship between adjusted positions in the x dimension and adjusted positions in the z dimension for particle 1 In this example, when particle 1 is at its rest position, its position in the x dimension is x₀ and its position in the z dimension is z₀. When the processor 112 moves particle 1 to the same position of the display 122 as the user's digit, the position of particle 1 in the x-dimension is adjusted to x₁ and the position of particle 1 is adjusted in the z-dimension to z₁, in accordance with the relationship. The relationship may, for example, be stored as part of the data 119 in the memory 114.

When the processor 112 has adjusted (where necessary) the positions of attached particles 1, 4, 8, 12 and 16, the flow chart of FIG. 6 proceeds to block 148. At block 148, the value of i is incremented by 1 to initiate the second iteration of blocks 142-147.

At block 149 of FIG. 6, the processor 112 determines whether the value of i is less than or equal to I. If i is less than or equal to I, the flow chart proceeds to block 150. If i is more than I, the flow chart proceeds to point 151. The value of I determines the total number of iterations that will be performed of blocks 142-147. Higher values of I may provide a more accurate simulation of a moving lamina but may be computationally more intensive. The inventors have found that a value of I of between 2 and 5 may be appropriate.

In this example, i=2 and I>2, so the flow chart of FIG. 6 proceeds to block 150, where n is reset to 1. The flow chart then returns to block 142 for iteration 2.

At block 142, since n=1, the processor 112 controls the relative spacing of particle 1 and its adjacent particles in the manner generally described above. That is, the processor 112 sequentially adjusts the relative spacing of particle 1 and each of its adjacent particles using the first distance relationship. This process is illustrated graphically in FIGS. 8A to 8C.

FIG. 8A illustrates particles 1, 2, 3, 5 and 9 in the array when the lamina 50 was at rest (before particle 1 moved in block 147 during iteration 1). The direction of movement of particle 1 in block 147 during iteration 1 is illustrated by the arrow 88 in FIG. 8A.

FIG. 8A also illustrates a straight line 202 passing through particles 1 and 2, a straight line 203 passing through particles 1 and 3, a straight line 205 passing through particles 1 and 5 and a straight line 209 passing through particles 1 and 9.

FIG. 8B illustrates particles 1 and 2 after particle 1 moved in block 147 during iteration 1. At block 142 of iteration 2, the processor 112 controls the relative spacing of particles 1 and 2 by applying the first distance relationship to them. The movement of particle 1 has resulted in particles 1 and 2 being separated by a distance smaller than a “rest length” of A. The processor 112 therefore applies the first distance relationship by adjusting the relative spacing of particles 1 and 2 to move particles 1 and 2 further away from each other. Each particle is moved an equal distance along a straight line 202 in three dimensional space passing through particles 1 and 2, such that particles 1 and 2 are then separated by a distance of A. The new positions of particles 1 and 2 are illustrated in FIG. 8B by dotted lines. Note that the straight line 202 in FIG. 8B has a different orientation of the straight line 202 in FIG. 8A, due to the movement of particle 1 from FIG. 8A to FIG. 8B.

FIG. 8C illustrates particles 1 and 5 after particle 1 has been moved by applying the first distance relationship to particles 1 and 2. The processor 112 then controls the relative spacing of particles 1 and 5 by applying the first distance relationship to them. The movement of particle 1, relative to its rest position, has resulted in particles 1 and 5 being positioned further from each other than when the lamina 50 is at rest. When the processor 112 applies the first distance relationship, it adjusts the relative spacing of particles 1 and 5 to move particles 1 and 5 closer to each other. Each particle is moved an equal distance along a straight line 205 in three dimensional space passing through particles 1 and 5, such that particles 1 and 5 are separated by a distance of A. The new positions of particles 1 and 5 are illustrated in FIG. 8C by dotted lines.

In this example, particles 2 and 5 are the only adjacent particles to particle 1, so the flow chart of FIG. 6 then proceeds to block 143.

At block 143, since n=1, the processor 112 controls the relative spacing of particle 1 and selected non-adjacent particles in the manner generally described above. The selected non-adjacent particles to particle 1, in this example, are particles 3 and 9. The adjustment of the relative spacing of particles 1 and 3 and particles 1 and 9 is illustrated in FIGS. 8D and 8E.

FIG. 8D illustrates particles 1, 2 and 3 after the first distance relationship has been applied to particles 1 and 5. At this stage, particles 1 and 2 have different positions from their rest positions. Particle 3 is still at its rest position.

The processor 112 controls the relative spacing of particles 1 and 3 by applying the second distance relationship to them. The movement of particle 1 has resulted in particles 1 and 3 being separated by a distance smaller than a “rest length” of 2A.

The processor 112 determines the difference between the current spacing of particles 1 and 3 and a rest length of 2A. The processor 112 then applies the second distance relationship by adjusting the relative spacing of particles 1 and 3 to move particles 1 and 3 further away from each other. Each particle is moved an equal distance, by a portion of the difference in spacing, along a straight line 203 in three dimensional space passing through particles 1 and 3.

FIG. 8D illustrates that after the relative spacing of particles 1 and 3 has been adjusted, particles 1 and 3 are separated by a distance that is greater than before the second distance relationship was applied, but is not quite 2A. The new positions of particles 1 and 3 are illustrated in FIG. 8D by dotted lines.

FIG. 8E illustrates particles 1, 5 and 9 after the second distance relationship has been applied to particles 1 and 3. At this stage, particles 1 and 5 have different positions from their rest positions. Particle 9 is still at its rest position.

The processor 112 controls the relative spacing of particles 1 and 9 by applying the second distance relationship to them. The movement of particle 1 has resulted in particles 1 and 9 being separated by a distance greater than a “rest length” of 2A.

The processor 112 determines the difference between the current spacing of particles 1 and 9 and a rest length of 2A. The processor 112 then applies the second distance relationship by adjusting the relative spacing of particles 1 and 9 to move particles 1 and 9 further away from each other. Each particle is moved an equal distance, by a portion of the difference in spacing, along a straight line 209 in three dimensional space passing through particles 1 and 9.

FIG. 8E illustrates that after the relative spacing of particles 1 and 9 has been adjusted, particles 1 and 9 are separated by a distance that is greater than before the second distance relationship was applied, but is not quite 2A. The new positions of particles 1 and 9 are illustrated in FIG. 8E by dotted lines.

The position values for each of the particles 1, 2, 3, 5 and 9 are stored as part of the data 119 in the memory 114.

At block 145, n is incremented by 1 to 2. Since n=2 and N=16, the flow chart proceeds from block 146 to block 142. The flow chart of FIG. 6 proceeds through blocks 142-143 for each value of n until n reaches 17, where the flow chart proceeds to block 147.

At block 147, the processor 112 adjusts the positions for any particles that are “attached”. In this example, this involves adjusting the positions of fixed particles 4, 8, 12 and 16 in the manner described above. It also involves adjusting the position of particle 1 such that it is at the user's swiping digit, as described above.

The processor 112 continues adjusting the relative spacing of the particles until i is smaller than I (that is, until the total number of iterations is reached). At that stage, the flow chart moves to point 151. At point 151, the flow chart follows two paths. On one path, the flow chart proceeds to arrow 153, where the processor 112 controls the display 122 to display a frame in the simulation of a moving lamina 50. The processor 112 uses the particle positions output by from block 149 to display the lamina 50.

On the other path, the flow chart proceeds from point 151, along line 152, to block 131. At block 131, the processor 112 uses the current positions of the particles (used to display the current frame in the simulation) and the previously displayed positions of the particles (used to display the previous frame showing the lamina 50 at rest) to determine new positions for the particles 1-16.

As described above, at block 131, the processor 112 treats the particles as free particles that are moving with a constant velocity. In block 131, the processor 112 determines the next positions by extrapolating from the current and previous positions of the particles. This process at block 131 causes the lamina 50 to continue moving even when the user 86 has ceased swiping his digit across the display 122.

The positions determined in block 131 are then adjusted as the flow chart moves through blocks 142 and 143 for each particle in each iteration, as described above. The particle positions output from block 147 are used by the processor 112 to display the next frame of the simulation at arrow 153, and the particle positions used to display that frame are fed back to block 131 to enable the simulation to continue.

FIG. 9 illustrates an example of a lamina 50 moving in accordance with embodiments of the invention. The lamina 50 is shown to be bending in response to the input provided by the user 86. The arrows 90-95 indicates movement of particles 1, 2, 5, 6, 9 and 13 from their rest positions as the lamina 50 moves.

Embodiments of the invention provide a simulation of a moving lamina 50 (such as a leaf of an electronic book) that is modeled using an array of particles. Movement of the lamina 50 may be initiated by user input.

In the method described above, user input results in movement of one or more particles of the lamina 50 in block 147. In circumstances where the user input is only provided in two dimensions (for example, by touching/swiping a two dimensional surface of a touch sensitive display 122), the method advantageously provides a mechanism for causing three dimensional movement of the lamina 50.

The movement of the lamina 50 displayed on the display 122 appears to be realistic to the user because of the manner in which the relative spacing of the particles is controlled to produce the movement.

As mentioned above, controlling the relative spacing of adjacent particles using the first distance relationship restricts the movement of the adjacent particles, causing the particles in the array 17 to behave as an interconnected system.

Controlling the relative spacing of selected non-adjacent particles using the second distance relationship causes the lamina 50 to appear to be stiffer than would otherwise be the case. It may be possible to alter the apparent stiffness of the lamina 50 by altering the non-adjacent particles that are “selected” for application of the second distance relationship. In some embodiments of the invention, the processor 112 may control the display 122 to provide a user selectable option for selecting the stiffness of the lamina 50. Following the selection of a stiffness using the option, the processor 122 selects appropriate non-adjacent particles for each particle, depending on the selected stiffness, for use in applying the second distance relationship. The processor 122 then controls the display 122 to display a user bendable lamina 50 having the stiffness selected by the user.

FIG. 10 illustrates an example of a method according to embodiments of the invention. At block 30 of FIG. 10, the processor 112 controls the display 122 to display a user movable lamina 50 modeled using an array of particles 17.

At block 32 of FIG. 10, the processor 112 controls movement of the user movable lamina 50 on the display 122 by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

FIG. 11 illustrates an example of how a lamina 50 may interact with other elements that are displayed on the display 122, and how those other elements may provide external constraints to the movement of a lamina 50. For example, FIG. 11 illustrates how the processor 112 may control a lamina 50B to prevent it from passing through another lamina 50C on the display 122.

The reference numeral 1A in FIG. 11 indicates the original, rest position of particle 1 of the lamina 50A. The reference numeral 1B in FIG. 11 indicates the original, rest position of particle 1 of the lamina 50C. The reference numeral 250 indicates a “rest plane” 250 that is substantially parallel to x-y plane and substantially parallel to the plane defined by the laminas 50B and 50C when they are at rest. The reference numeral 1C′ indicates the current position of particle 1 of the lamina 50C.

FIG. 11 indicates a situation where, prior to the display of a frame of the simulation, the position of particle 1 and other particles in the lamina 50B have been calculated such that a portion of the lamina 50B appears to have passed through another lamina 50C. The processor 112 is configured to identify such a situation and alter the co-ordinates of the relevant particles accordingly, before those particle positions are used to display a frame of the simulation. For example, the position of particle 1 of the lamina 50B may be adjusted from the position identified by the reference numeral 1B′ to the position identified by the reference numeral 1B″.

For instance, in respect of particle 1, the processor 112 may identify this situation by determining one or more angles for particle 1. For example, the processor 112 may:

i) determine an angle that a line, defined to pass through the current position 1B′ of particle 1 in the lamina 50B and the original position 1B of particle 1 in the lamina 50B, makes with the rest plane 250;

ii) determine an angle that a line, defined to pass through the current position 1C′ of particle 1 in the other lamina 50C and the original position 1C of particle 1 in the other lamina 50C, makes with the rest plane 250; and

iii) if the angle determined in i) is smaller than the angle determined in ii), conclude that particle 1 of the lamina 50B has passed through the lamina 50C and adjust its position appropriately.

In some embodiments of the invention, one or more laminas 50A,B,C may be displayed on the display 122 with other user interface elements (for example, selectable menu options). The reference numeral 260 defines an example of one such user interface element. The processor 112 may analyze the determined position of each particle, before they are used to display a frame of the simulation, to determine whether they position a lamina 50A within a user interface element 260. If so, the processor 112 may alter the position of the particles to map lamina onto a surface of the user interface element 260, as shown in FIG. 11.

In some embodiments of the invention, the method includes an “automatic completion” feature, where a moving lamina is guided from its initial position (for example, defined by the solid lines in FIG. 4) to its final position (for example, defined by the dotted lines in FIG. 4). For instance, in an electronic book implementation, this enables a full “page turn” to be achieved even if the input the user provides to guide the page across the display 122 is limited.

For example, in order to “automatically complete” movement of the lamina 50 the processor 112 may alter the position of each particles that is output from block 131, before blocks 142, 143 are performed, in order to guide the lamina 50 to its final position. For instance, the processor 112 may begin to guide the movement of a particular particle when that particle has passed a threshold. For example, guidance of particle 1 may begin when the x co-ordinate value of the position of particle 1 has passed a threshold.

In some embodiments of the invention, the method described above may include other, optional features. For example, in some embodiments of the invention, the processor 112 may account for the effects of external factors such as gravity and/or wind. For example, the apparatus 120 may include one or more accelerometers for sensing the direction that gravity is acting in. The processor 112 may, for example, take the effects of gravity into account when determining the positions of the particles in block 131.

The apparatus 120 may optionally include a sensor for sensing wind direction and/or wind strength. The sensor may, for example, be a dedicated wind sensor or one or more accelerometers that sense movement of the apparatus 120. The inputs from the sensor can be used, by the processor 112, to simulate effects of acceleration and air pressure for the lamina. Optionally, the processor 112 may alter the position of each particle that is output from block 131 to simulate a wind effect. This will cause the lamina 50 to appear, on the display 122, as if it is blowing in the wind. This may be done, for example, by adding a constant value and a (smaller) random value to the position of each particle that is output from block 131. The constant value that is added may, for example, depend upon the direction and/or the strength of the wind sensed by the sensor of the apparatus 120.

In some implementations of the invention, processor 112 may enable a user to fold or tear off portions of a lamina 50. In such implementations, the processor 112 may control the display 122 to display a portion of the lamina 50 being torn off if user's digit drags one or more particles more than a threshold distance away from their adjacent particles in block 147 of FIG. 6. A user could perform this action, for example, by holding one or more particles in place by holding one finger in a particular position on the display 122 and by simultaneously dragging other particles away from that/those particle(s) by swiping another finger across the display 122. After a portion of the lamina 50 has been torn off, the relative spacing of particles situated on different portions of the lamina 50 are not adjusted using the first and second distance relationships.

The processor 112 may control the display 122 to display a folded portion of the lamina 50 if selected, non-adjacent particles are spaced closer than a threshold distance from one another after block 147 of FIG. 6 is performed. A folded portion may be created by modifying the second distance relationship to those particles. This would happen when the relative spacing between the particles is forced, by the user, to be smaller than a given threshold. The modified second distance relationship may define a shorter “rest length” between particles than the original second distance relationship. For example, if the original second distance relationship defines a rest length of 2A, the threshold could be 1A and the modified second distance relationship may define a rest length of 1.5A. The selected non-adjacent particles may be moved towards or away from one another by a portion of the current difference in spacing, using the third distance relationship, in a similar manner to that described above in relation to the application of the second distance relationship.

References to ‘computer-readable storage medium’, ‘computer program product’, ‘tangibly embodied computer program’ etc. or a ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:

(a)hardware-only circuit implementations (such as implementations in only analog and/or digital circuitry) and

(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and

(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

The blocks illustrated in FIGS. 6 and 10 may represent operations in a method and/or sections of code in the computer program 116. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed. For example, the user may provide user input to move a lamina 50 using a mouse rather by swiping his finger across the display 122.

In the loop containing blocks 142, 143, 145 and 146 of FIG. 6, the first and second distance relationships are each applied twice to the relative distance between two particles before the next iteration of the flow chart is commenced (when i is incremented at block 148). In some alternative implementations of the invention, each of the first and second distance relationships are only applied once to the relative distance between two particles before the next iteration of the flow chart is commenced. Also, the relative spacing between the particles may be adjusted in a less orderly fashion than that described above in relation to FIG. 6, for example using a randomly hashed sequence.

In the implementations of the invention described above, the condition of the first distance relationship specifies that if particle n and an adjacent particle are not spaced a “rest length” away from each other, particle n and an adjacent particle are moved towards or away from one another by an equal amount until they are separated by a rest length. In other implementations, the amount by which the positions of particle n and an adjacent particle are adjusted may be smaller, so that following adjustment they are separated by more or less than a rest length.

The Figures illustrate a lamina 50 that has four sides/edges, one of which is substantially fixed. In some embodiments of the invention, the lamina 50 may have more or less than four sides. Also, it is not necessarily for the whole of one side of the lamina 50 to be fixed. The whole or part of a side of a lamina 50 (that is, all or some of the particles representing a side of the lamina 50) may be fixed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method, comprising:
controlling a display to display a user movable lamina modeled using an array of particles; and
controlling movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

2. A method as claimed in claim 1, wherein the user movable lamina is a user bendable lamina.

3. A method as claimed in claim 1, wherein the user movable lamina is a leaf of an electronic book.

4. A method as claimed in claim 1, wherein the user movable lamina has a perimeter defined by at least four sides, at least part of one side is substantially fixed in position, and the user movable lamina is user rotatable about the fixed side.

5. A method as claimed in claim 1, wherein the array comprises particles arranged in rows and columns when the user movable lamina is at rest, the first particle is positioned in a particular column and a particular row, and each of the at least one other particles, adjacent to the first particle, is positioned:
in a column adjacent to the particular column and in the particular row; or
in the particular column and in a row adjacent to the particular row.

6. A method as claimed in claim 5, wherein when the user movable lamina is at rest, each of the at least one further particles, not adjacent to the first particle, is positioned:
in the particular row and in a column that is separated from the particular column by at least one other column; or
in the particular column and in a row that is separated from the particular row by at least one other row.

7. A method as claimed in claim 1, wherein movement of the user movable lamina is controlled by controlling, using the first distance relationship, relative spacing of the first particle and one of the other particles adjacent to the first particle in the array, and by subsequently controlling, using the first distance relationship, relative spacing of the first particle and another one of the other particles adjacent to the first particle in the array.

8. A method as claimed in claim 1, wherein movement of the user movable lamina is controlled by controlling, using the second distance relationship, relative spacing of the first particle and one of the further particles not adjacent to the first particle in the array, and by subsequently controlling, using the second distance relationship, relative spacing of the first particle and another one of the further particles not adjacent to the first particle in the array.

9. An apparatus, comprising:
at least one memory storing a computer program comprising computer program instructions; and
at least one processor configured to execute the computer program instructions to cause the apparatus at least to:
control a display to display a user movable lamina modeled using an array of particles; and
control movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

10. An apparatus as claimed in claim 9, wherein the user movable lamina is a leaf of an electronic book.

11. An apparatus as claimed in claim 9, wherein the user movable lamina has a perimeter defined by at least four sides, at least part of one side is substantially fixed in position, and the user movable lamina is user rotatable about the fixed side.

12. An apparatus as claimed in claim 9, wherein the array comprises particles arranged in rows and columns when the user movable lamina is at rest, the first particle is positioned in a particular column and a particular row, and each of the at least one other particles, adjacent to the first particle, is positioned:
in a column adjacent to the particular column and in the particular row; or
in the particular column and in a row adjacent to the particular row.

13. An apparatus as claimed in claim 12, wherein when the user movable lamina is at rest, each of the one or more further particles, not adjacent to the first particle, is positioned:
in the particular row and in a column that is separated from the particular column by at least one other column; or
in the particular column and in a row that is separated from the particular row by at least one other row.

14. An apparatus as claimed in claim 9, wherein movement of the user movable lamina is controlled by controlling, using the first distance relationship, relative spacing of the first particle and one of the other particles adjacent to the first particles in the array, and by subsequently controlling, using the first distance relationship, relative spacing of the first particle and another one of the other particles adjacent to the first particle in the array.

15. An apparatus as claimed in claim 9, wherein movement of the user movable lamina is controlled by controlling, using the second distance relationship, relative spacing of the first particle and one of the further particles not adjacent to the first particle in the array, and by subsequently controlling, using the second distance relationship, relative spacing of the first particle and another one of the further particles not adjacent to the first particle in the array.

16. An apparatus as claimed in claim 9, further comprising the display.

17. A non-transitory computer readable medium storing a computer program comprising computer program instructions that, when executed by at least one processor, cause at least the following to be performed:
controlling a display to display a user movable lamina modeled using an array of particles; and
controlling movement of the user movable lamina on the display by controlling, using a first distance relationship, relative spacing of a first particle in the array and at least one other particle adjacent to the first particle in the array, and by controlling, using a second distance relationship, relative spacing of the first particle and at least one further particle not adjacent to the first particle in the array.

18. An apparatus, comprising:
at least one memory storing a computer program comprising computer program instructions; and
at least one processor configured to execute the computer program instructions to cause the apparatus at least to:
control a display to provide a user selectable option for setting a stiffness of a user bendable lamina; and
control the display to display a user bendable lamina having the stiffness selected by the user.

19. An apparatus as claimed in claim 18, wherein the user bendable lamina is a user bendable leaf of an electronic book.

20. An apparatus as claimed in claim 19, wherein the user bendable leaf has a perimeter defined by at least four sides, at least part of one side is substantially fixed in position, and the at least one processor is configured to cause the apparatus to: enable the leaf to be rotated on the display, by the user, about the fixed side.
